(19) United States
(12) Patent Application Publication
(10) Pub. No.: US 2012/0222590 A1
(43) Pub. Date: Sep. 6, 2012

(54) ARMOR KIT IN A SAFE AND A METHOD OF INSTALLATION OF AN ARMOR KIT IN A SAFE

(75) Inventors: Ronaldo Marques, Santana de Parnaiba SP (BR); Vanderley De Assis Reis, Sumare (BR)

(73) Assignee: Itautec S.A.- Grupo Itautec, Bela Vista (BR)

(21) Appl. No.: 13/395,632

(22) PCT Filed: Sep. 14, 2010
(86) PCT No.: PCT/BR2010/000296

§ 371 Date: May 18, 2012

(30) Foreign Application Priority Data
Sep. 18, 2009 (BR) PI0903204-5

(51) Int. Cl. E05G 1/024; F41H 5/013; B23P 11/00; G07F 19/00

(52) U.S. Cl. 109/78; 29/428

(57) ABSTRACT

The invention is related to an armor kit in a safe, the said kit consisting in armor plates (11, 12, 15, 18) that are juxtaposed to the inner walls of the safe of ATMs and similar equipment, where the attachment of the said plates to the said walls is provided by way of removable retention means, such as screws fitted in threaded holes previously present in the said walls. The kit further comprises means for rigid joining between plates, such means consisting in flat perforated metal plates (13) or in plates that are folded/bent to form angle pieces (16, 19), provided with through-holes for the accommodation of screws. The installation of the kit may be provided without the need to remove the safe from the location where it is installed, and comprises, initially, the fastening of armor plates (11, 12) onto the inner face of the front wall (46) of the safe, followed by the attachment of the armor plates (15, 18) to the inner face of one of the side walls (44), as well as the rigid joining between the said plates, with the further possibility of installation of a horizontal armor plate (33) provided in parallel to the upper wall (43) of the safe by means of angle pieces (31, 32) that are intended for guiding and supporting purposes.

### FIELD OF THE INVENTION

The present invention is related to the protection of safes against break-in, and it is more particularly related to the installation of armoring elements in safes associated with bank service terminals—ATM's—and similar field-installed equipment.

### SUMMARY OF THE PRIOR ART

The ATM equipment units, commonly known as “electronic tellers” are used in usually crowded places—such as in supermarkets, fuel filling stations, airports, etc.—to enable to performance of various types of financial operations, such as payments, checking of bank statements, and particularly, the drawing of currency by means of the use of cards and/or passwords. Obviously, in order to provide the latter function, the ATMs must store a significant stock of currency bills, that are accommodated in specific magazines or storage spaces that are in turn placed in specific parts of the cabinet of these ATM's, commonly designated as safes.

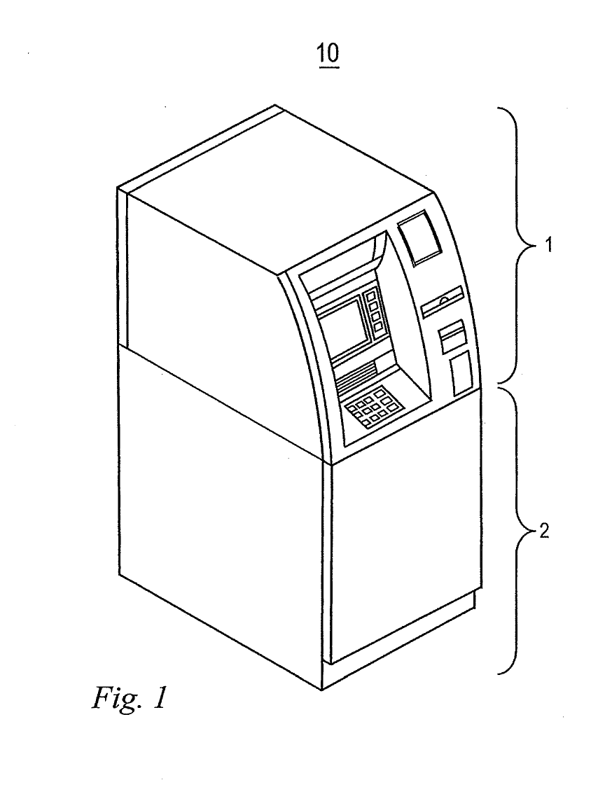

In FIG. 1 there is depicted a typical model of ATM 10, wherein the upper portion 1 of the cabinet comprises the user interface devices, such as a card reader, a keypad, a video screen, etc. The safe in which the currency is stored occupies the lower portion 2 of the cabinet, and the communication thereof with the interface devices is provided by means of a relatively narrow slot, whose dimensions and position do not allow the extraction of the currency bills stored therein. Since the break-in of these safes constitutes the method that is most commonly used for extraction of the currency, such safes are manufactured with reinforced walls in order to hinder the efforts of the burglars.

There are already known various externally applied armor shields, which purpose is to provide an additional obstacle—in addition to the structure of the walls themselves—against break-in. Thus, for example, in patent document no. PI 0104638-1, which title is [in Portuguese] “Sistema de segurança e blindagem para equipamentos acondicionadores de valores e equivalentes” [A safety and armoring system for valuables storage and similar equipment] there is described a safety armor that is externally applied to the safe, comprised by front, back and side walls, each of these being formed of two carbon steel plates with a thickness of 19 mm, provided in parallel, with the space between these plates being filled with a slurry of cement mixed with an aluminum oxide additive for enhanced hardness. The outer sides of these walls are coated with a chemical shield comprised of paint impregnated with tar and sulfur. Upon being subjected to intense heat, such as that arising from the action of a blowtorch, this composition releases smoke and toxic gasses, rendering it impossible for the eventual burglar to remain in its vicinity.

One of the disadvantages of the object of the cited patent application resides in the fact that the chemical shielding is located on the outer surface of the protecting walls, which facilitates the removal thereof with solvent and a scraper, thereby neutralizing its purpose.

In patent application no. PI 0403799, which title is [in Portuguese] “Metodologia para reforço de instalações e equipamentos bancários” [A methodology for reinforcement of banking installations and equipment] there is provided the installation of external jackets in ATMs and similar equipment, comprising protective panels or jackets in the form of flattened boxes made of metal plate, that are mounted externally next to the equipment sides. These panels are provided, internally, with a first layer of material designed to provide resistance to attack by blowtorch, such material being essentially comprised by a flammable compound containing bitumen, pitch and sulfur. The mechanical protection is provided by a layer of concrete reinforced with steel bars, in addition to the components usually employed to make concrete, specified amounts of Koridon and Dramix, the first being an aluminum trioxide-based abrasive and the second being constituted by numerous steel fibers. The attachment of these jackets to the cabinet is provided with the use of screws and/or bolts and nuts, from the inner part of the safe.

The armor systems disclosed in the two cited documents exhibit the disadvantage of being easily detected by the burglars, allowing the same to previously equip themselves with means, tools and devices capable of penetrating the said shielding panels.

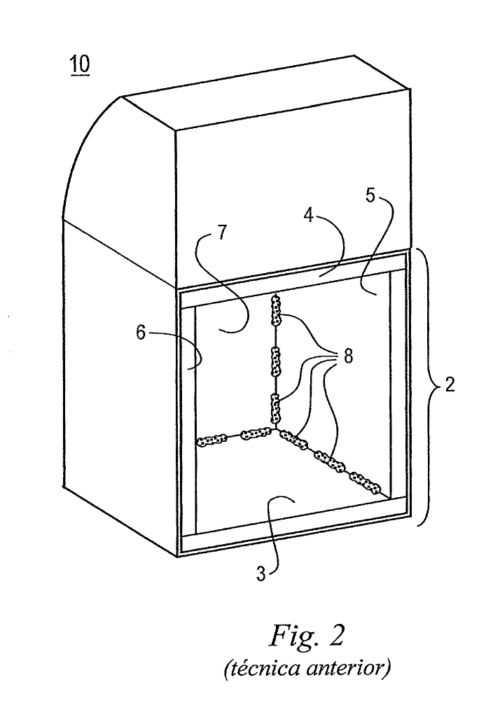

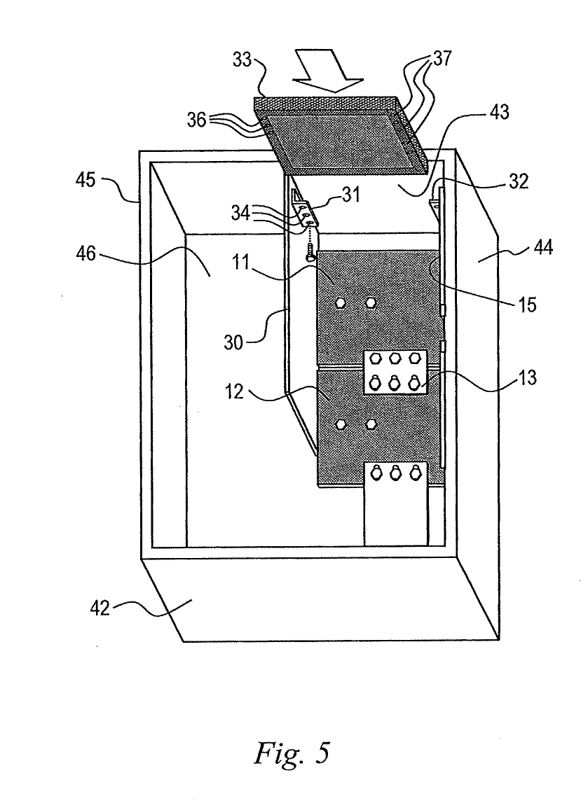

Taking this disadvantage into consideration, the filing applicant of the instant application has developed an armor system as described in patent application no. PI 0803602-0, wherein the protective elements are applied internally to the safe. According to the illustration of FIG. 5 of that document, which is presently reproduced in FIG. 2 of the instant application, the safe 2, located at the lower portion of the ATM 10, is provided with a set of armor plates 3, 4, 5, 6 and 7 that are juxtaposed to the inner faces of the lower, upper, side and front walls, respectively, the said plates being joined to one another along the edges thereof by means of weld seams 8.

The object of the said application solves some problems that are inherent to those of the prior art, since the internal placement of the armor plates renders these elements practically inaccessible, and substantially hinders the attempts at break-in. However, the installation thereof requires the use of special equipment such as welding machines that, notwithstanding the fact that they exist in industrial facilities, are not always available or cannot always be used in the environments wherein the ATMs are installed.

### OBJECTS OF THE INVENTION

In light of what has been set forth above, the object of the present invention is the provision of an armor system using armor plates applied internally to the safe, capable of providing an adequate level of protection against break-in attempts.

One other object is the provision of an armor system that may be applied to safes already installed in the field, avoiding the need of removal thereof to be retrofitted at the factory.

One other object is the provision of a method of application of the armor using ordinary tools, obviating the use of equipment that is normally not available in the field, such as welding machines.

### BRIEF DESCRIPTION OF THE INVENTION

The above and other objects are fulfilled by the invention by means of the provision of a system that comprises at least one armor plate juxtaposed over the inner face of at least one of the walls of the safe, the said at least one plate being attached to the said wall by means of at least one removable mechanical fastening element that is inaccessible from the outside.

According to one other characteristic of the invention, the said system comprises two or more armor plates, mutually bound by means of removable joining means that are inaccessible from the outside, wherein one of the said plates is directly attached to one inner wall of the safe.

According to another characteristic of the invention, the said mechanical fastening element of the said at least one armor plate to the inner wall comprises a screw.

According to another characteristic of the invention, the said means for joining the armor plates comprise joining plates and threaded elements.

According to one other characteristic of the invention, the method of assembly comprises the attachment of at least one plate to one of the inner faces of the safe by means of at least one removable mechanical fastening element, followed by the joining of at least one other plate to the preceding one by means of at least one joining element.

According to another characteristic of the invention, the said joining element is provided by a metal plate bent in the shape of an angle piece, positioned on the concave dihedral formed by the approximation of the armor plates thus joined.

According to one other characteristic of the invention, the said threaded elements comprise screws that are screwed into threaded holes provided in at least one of the walls of the safe.

### DESCRIPTION OF THE FIGURES

Further characteristics and advantages of the invention will become more apparent from the description of an exemplary and non-limitative embodiment thereof and of the figures that refer thereto, in which:

In FIG. 1 there is depicted the external aspect of a banking self-service terminal (ATM), viewed from the perspective of the side of usage thereof.

In FIG. 2 the same ATM is shown, viewed from the back, illustrating the fitting thereto of the internal armor plates in accordance with application no. PI 0803602-0.

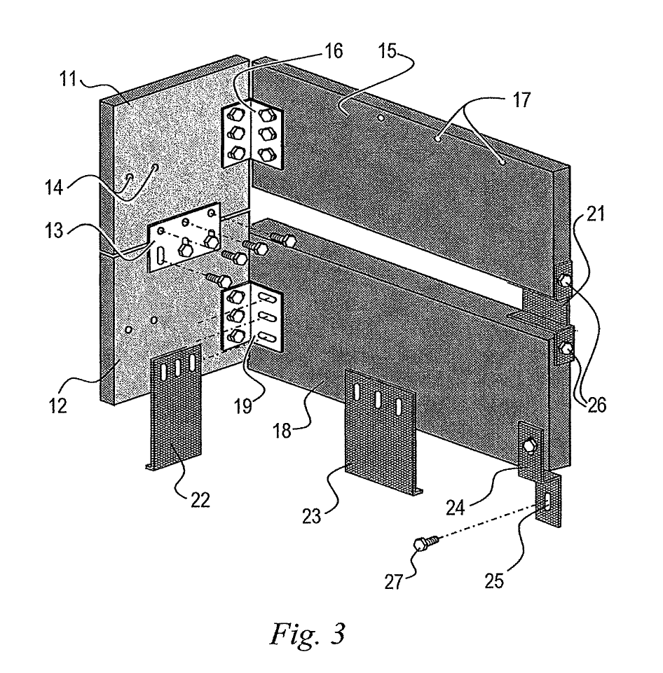

In FIG. 3 there is depicted an embodiment of the present invention, showing the side armor panels prior to the installation thereof inside the safe.

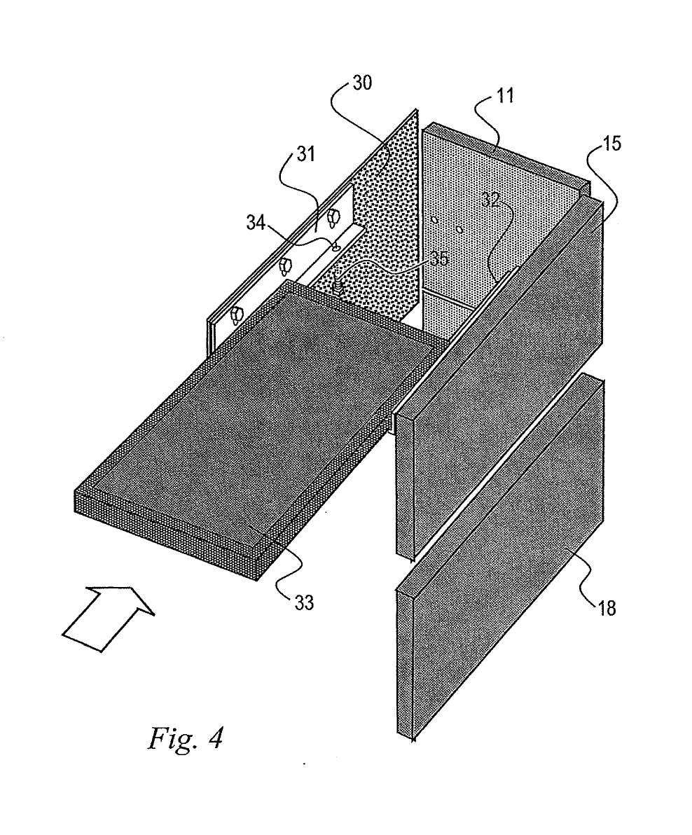

In FIG. 4 there is shown the set of armor panels of the preceding figure, with the addition thereto of an upper armor panel.

In FIG. 5 there is illustrated the installation of the armor kit inside a safe.

### DETAILED DESCRIPTION OF THE INVENTION

According to FIG. 3, the kit that constitutes the object of the present invention comprises, in a preferred embodiment, a first and a second armor plates 11 and 12 that are juxtaposed to the inner face of the front wall of the safe (not shown), there being used for that purpose a number of screw-type fastening elements that are passed through the through-holes 14 of the plates, to be inserted into threaded holes (not shown) previously present in the said front wall, in positions that are coincident with those of the said through-holes. These plates may be joined to one another by means of a mechanical joining element consisting in a plate 13 and the corresponding screws that are made to pass through a number of through-holes in the said plate, and are accommodated in threaded holes provided in the said armor plates (not shown in the figure). The first plate 11 is mechanically associated to a third armor plate 15 that is positioned near the inner face of the side wall of the safe, with the joining of the two plates to one another being provided by one other mechanical joining element that is provided by a plate bent into the shape of an angle piece 16 and by the respective screws (not indicated by reference symbols). In turn, the second plate 12 is mechanically associated to a fourth plate 18, also juxtaposed to the inner face of the side wall of the safe, by means of a mechanical joining element consisting in a plate bent into the shape of an angle piece 19. The said third and fourth plates are mutually associated by means of a joining piece 21 configured from the bending of a metal plate, provided with through-holes through which are fitted screws 26 that are accommodated within threaded holes provided at the edges of the said plates.

Further according to what is depicted in FIG. 3, the said second and fourth armor plates are supported on the lower wall (not shown) of the safe by means of the supporting plates 22 and 23, which are affixed next to the lower edges of the said plates by screws. The fourth armor plate can also be secured to the side wall of the safe by means of an L-shaped clamp 24 which upper tab is fastened to the said plate by screws and which lower tab is provided with a through-hole 25 that is penetrated by a fastening screw 27 of this clamp and is accommodated within a threaded hole previously provided in the side wall of the safe. In an alternative embodiment, the said fourth armor plate may have its vertical dimension larger than that which is illustrated in the figure, allowing the said clamp to be dispensed with, in which case the attachment thereof to the said side wall is provided by a screw which is made to pass through a through-hole and is accommodated in the said threaded hole.

In FIG. 4 there is shown a second preferred embodiment of the invention, in which there is provided a fifth armor plate 33 juxtaposed to the upper wall of the safe (not shown in this figure). As illustrated, this plate is inserted slidably between two guiding angle pieces 31 and 32, the first of these being secured to a partition 30 located in the safe in order to separate the compartment wherein are housed the magazines containing the currency bills, and the second piece being secured to the inner face of the armor plate 15, by means of screws inserted in the threaded holes 17 (visible in FIG. 2). Upon conclusion of the insertion, the said fifth plate is retained in that position by means of screws 35 that are made to pass through through-holes 34 in the lower tab of the said angle pieces.

In the preceding description the retention of the armor plates at the walls of the safe was provided by removable retaining means, in the form of screws screwed into threaded holes opened from the inner faces of the said walls. However, other retention means can be used such as, for example, expansible bushings inserted in non-threaded blind holes opened in the said walls, stud bolts projecting from the said walls into the cavity of the safe, and other equivalent means.

Now referring to FIGS. 3, 4 e 5, the main steps comprised in the assembly of the armor kit are listed in the following:
juxtaposition of the first (11) and the second (12) armor plates to the inner face of the front wall 46 of the safe and fastening of the same by means of screws that are made to pass across through-holes (14) in the said plates, screwing their ends into preexisting threaded holes in the said wall;
placement and fastening of the joining plate (13) between the said plates;
preassembly of the fourth armor plate (18) comprising the fastening of the angle piece 24 and the supporting plate 23, using screws that are screwed in threaded holes provided in the said plate;
juxtaposition of the said fourth armor plate internally to the side wall 44 of the safe and joining thereof to the second plate 12 by means of the angle piece 19 and the respective screws;
fastening of the said fourth armor plate to a preexisting threaded hole in the side wall 44 of the safe by means of a screw 27 that is made to pass through the hole 25 in the clamp 24;
fastening of the joining piece 21 to the armor plate 18 by means of a screw 26;
positioning of the third armor plate 15 and juxtaposition thereof to the inner face of the side wall of the safe, followed by the attachment thereof to the first armor plate 11 by means of the angle piece 16;
joining of the said third armor plate to the fourth armor plate 18 by means of screwing to the joining piece 21.

In the sequence of operations described above, the positioning of the second and fourth armor plates is complemented by the support provided by the supporting plates 22 and 23, which lower ends are supported on the inner face of the lower wall 42 of the safe.

In the case where the fifth armor plate 33 is used, the subsequent assembly steps are those described in the following:
fastening of the guiding angle piece 32 to the third armor plate 15, by means of screws screwed into the threaded holes 17 provided in the said plate;
fastening of the guiding angle piece 31 to the partition 30 by means of screws (in the case that there are provided threaded holes in the said partition) or by means of nut and bolt assemblies (in the case that the said holes are through-holes and are not threaded);
insertion of the fifth armor plate 33 by means of sliding thereof on the angle pieces 31 and 32;
retention of the said fifth armor plate in its final position, by means of screws 35 inserted in the holes 36 of the said plate 33, as indicated in FIG. 5. These screws pass through the through holes 34 in the lower tabs of the said angle pieces 31 and 32.

Notwithstanding the fact that the invention was described based on a specific embodiment thereof, it should be understood that there may be introduced modifications in the inventive concept presently set forth, without exceeding the conceptual limits of the invention, which is defined by the set of claims that follows.

1. An armor kit in a safe comprising at least one armor plate and respective fastening means, characterized by the fact that at least one plate is juxtaposed to one of the inner walls of the safe and directly fastened thereto by means of removable retention means.

2. A kit as claimed in claim 1, characterized by comprising two or more armor plates, wherein at least one of these is directly secured to the inner face of one of the walls of the safe and coupled to at least one other armor plate by way of rigid mechanical joining means.

3. A kit as claimed in claim 2, characterized in that the said rigid mechanical joining means comprise metal plates and screws.

4. A kit as claimed in claim 3, characterized in that at least one first armor plate is juxtaposed to the front wall of the safe and a third armor plate, rigidly attached to the said first plate by way of rigid mechanical joining means is juxtaposed to the side wall of the safe.

5. A kit as claimed in claim 1, characterized by the fact of additionally comprising an upper armor plate juxtaposed to the upper wall of the safe.

6. A kit as claimed in claim 4, characterized in that the said upper armor plate is applied by sliding on guiding angle pieces, one of these being attached to the upper portion of the said third plate and the other being attached to the upper portion of a partition plate that delimits the compartment wherein are stored the currency bill magazines.

7. A method for the installation of an armor kit in a safe, the said armor being defined in claim 1, characterized by comprising the fastening of the first and of the second armor plates to the front wall of the safe, by means of the juxtaposition of such plates to the inner surface of the said wall, to which they are attached by way of removable retention means, followed by the juxtaposition, to the side wall, of the third and of the fourth armor plates and joining of the same to the said first and second plates by way of rigid mechanical joining means.

8. A method, as claimed in claim 7, characterized by comprising, subsequently, the attachment of a guiding angle piece to the upper region of the partition plate of the safe, and of another guiding angle piece to the upper region of the third armor plate, followed by the insertion of a horizontal armor plate by making the same slide between the said angle pieces.
